(19) United States
(12) Patent Application Publication
(10) Pub. No.: US 2025/0138619 A1
(43) Pub. Date: May 1, 2025

(54) ELECTRONIC DEVICE AND POWER SAVING METHOD THEREOF

(71) Applicant: ASUSTeK COMPUTER INC., Taipei City (TW)

(72) Inventors: Yi-Jing Chen, Taipei City (TW); Yu-Hao Hu, Taipei City (TW)

(73) Assignee: ASUSTeK COMPUTER INC., Taipei City (TW)

(21) Appl. No.: 18/827,862

(22) Filed: Sep. 9, 2024

(30) Foreign Application Priority Data
Oct. 27, 2023 (TW) 112141193

(51) Int. Cl. G06F 1/3234

(52) U.S. Cl. CPC G06F 1/3234

(57) ABSTRACT

An electronic device and a power saving method of the electronic device are provided. The power saving method includes following steps. A wake-up event is received in a low power consumption mode. Whether the wake-up event is an unexpected wake-up event is determined. Battery statistic data are analyzed to generate an analysis result when the wake-up event is the unexpected wake-up event. A status of a plurality of background applications operating in a background is adjusted according to the analysis result.

### CROSS-REFERENCE TO RELATED APPLICATION

This application claims the priority benefit of Taiwan application serial no. 112141193, filed on Oct. 27, 2023. The entirety of the above-mentioned patent application is hereby incorporated by reference herein and made a part of this specification.

### BACKGROUND

### Technical Field

The disclosure relates to an electronic device capable of automatically reducing activities of background applications during standby and a power saving method adopted by the electronic device.

### Description of Related Art

When a user leaves an Android-based electronic device unused for an extended period, the electronic device automatically enters a standby (system hibernation) low power consumption mode, such as a “doze mode”, so as to avoid unnecessary power consumption. Although the system in the low power consumption mode limits the processor usage and network activities of background applications operating in the background, the background applications consume system resources and may periodically wake up the system, thus leading to suboptimal power-saving results.

### SUMMARY

An embodiment of the disclosure provides a power saving method adapted to an electronic device and including following steps. A wake-up event is received in a low power consumption mode. Whether the wake-up event is an unexpected wake-up event is determined. When the wake-up event is the unexpected wake-up event, battery statistic data are analyzed to generate an analysis result. A status of a plurality of background applications operating in a background is adjusted according to the analysis result.

Another embodiment of the disclosure provides an electronic device that includes a memory and a processor. The memory stores a plurality of modules. The processor is coupled to the memory and loads and executes the modules stored in the memory. The modules include a wake-up detection module, a battery data collection and analysis module, and a power saving system module. The wake-up detection module receives a wake-up event in a low power consumption mode and determines whether the wake-up event is an unexpected wake-up event. The battery data collection and analysis module analyzes battery statistic data when the wake-up event is the unexpected wake-up event to generate an analysis result. The power saving system module adjusts a status of a plurality of background applications operating in a background according to the analysis result.

In light of the foregoing, the electronic device and the power saving method thereof, as described in one or more embodiments of the disclosure, may be applied to detect the unexpected wake-up events and in response dynamically adjust the status of the background applications operating in the background, so as to sequentially discontinue unnecessary background applications. As such, system resources may be appropriately released, resulting in optimal power saving outcomes and enhanced user experiences.

To make the above more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic block diagram illustrating an electronic device according to an embodiment of the disclosure.

FIG. 2 is a schematic diagram illustrating an architecture of a plurality of modules stored in the memory according to the embodiment depicted in FIG. 1.

FIG. 3 illustrates an example of expected wake-up events and unexpected wake-up events according to an embodiment of the disclosure.

FIG. 4 is a flowchart illustrating a power saving method according to an embodiment of the disclosure.

### DESCRIPTION OF THE EMBODIMENTS

Reference is now made in detail to exemplary embodiments of the disclosure, and examples of the exemplary embodiments are described in the accompanying drawings. Whenever possible, the same reference numbers are used in the drawings and descriptions to indicate the same or similar parts.

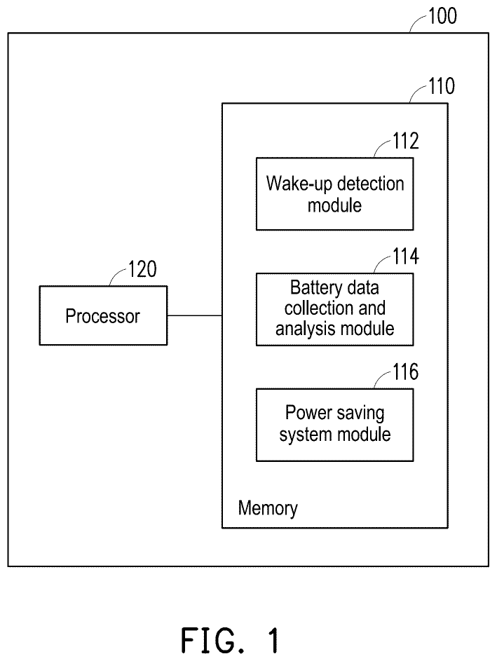

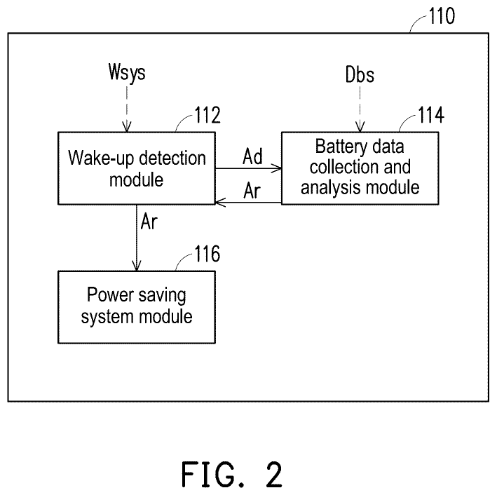

With reference to FIG. 1 and FIG. 2, an electronic device 100 provided in this embodiment is, for instance, a handheld electronic product, such as an Android-based phone or the like. The electronic device 100 includes a memory 110 and a processor 120.

The memory 110 is configured to store a plurality of modules including data, programming codes, and a combination thereof. The memory 110 may include, for instance, any type of fixed or movable random access memory (RAM), read-only memory (ROM), flash memory, hard disk, any other similar device, an integrated circuit, and a combination thereof.

The modules stored in the memory 110 include a wake-up detection module 112, a battery data collection and analysis module 114, and a power saving system module 116. The wake-up detection module 112 may be configured to detect a wake-up event Wsys received by the system. For instance, when the electronic device 100 is in a standby (system hibernation) low power consumption mode (such as a doze mode), the system may be awoken by receiving the wake-up event Wsys intermittently due to the need of receiving notifications, updating the system status, accessing the network, or utilizing other resources.

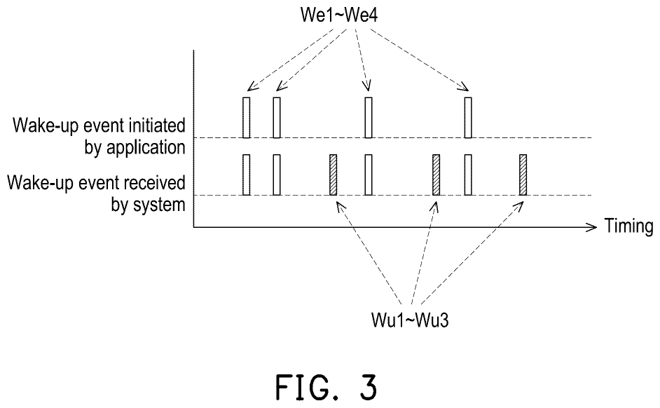

In this embodiment, the wake-up event Wsys may be categorized into an expected wake-up event and an unexpected wake-up event. The expected wake-up event is a wake-up event initiated by background applications that are still operating in the background in a low power consumption mode. The unexpected wake-up event is a wake-up event that is not initiated by the background applications in the low power consumption mode (e.g., a wake-up event initiated regularly by a timer in the electronic device 100, etc.). As shown in FIG. 3, the wake-up event initiated by applications includes expected wake-up events We1-We4 initiated at different timings. However, the wake-up event Wsys received by the system, in addition to the expected wake-up events We1-We4, further includes unexpected wake-up events Wu1-Wu3. Therefore, the wake-up detection module 112 may determine whether the wake-up event Wsys received by the system is the expected wake-up event or the unexpected wake-up event.

The battery data collection and analysis module 114 is configured to collect battery statistic data Dbs and analyze the battery statistic data Dbs to understand where and how the battery power is consumed by the applications and identify tasks in the applications that can be delayed or even removed. The battery statistic data Dbs, for instance, may be a performance testing tool (Batterystats) in an Android-based architecture and may include daily log data recording an activity history of each of the background applications. Whenever a background application is running, the battery data collection and analysis module 114 may record the content of the activity performed by the background application (such as waking up the system, accessing the network, collecting, analyzing, processing, downloading data, and so on) and the start time and the end time of the activity in the battery statistic data Dbs. The power consumption of each of the background applications may also be calculated based on the battery statistic data Dbs.

The power saving system module 116 may be configured to apply different power saving strategies to different background applications based on their current status, so as to optimize power saving performance and user experience.

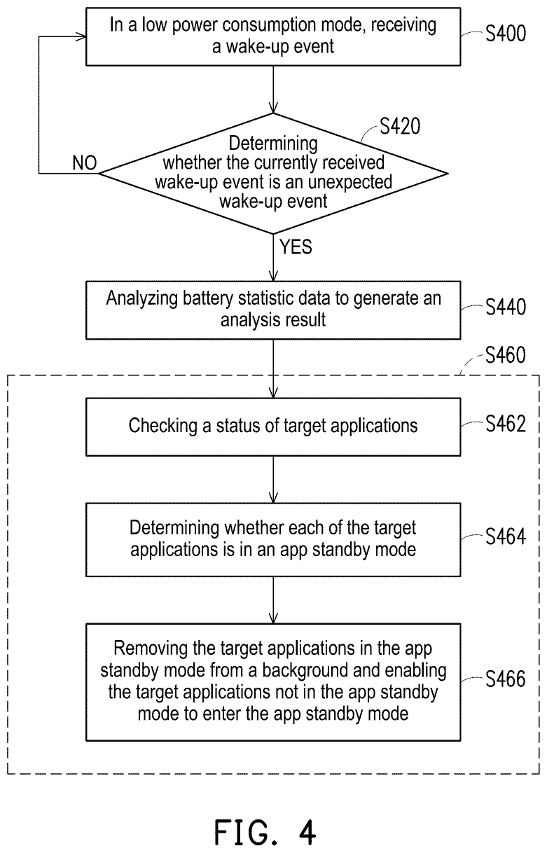

The processor 120, for instance, is a central processing Unit (CPU) or any other programmable general-purpose or special-purpose microprocessor, digital signal processor (DSP), programmable controller, application specific integrated circuit (ASIC), any other similar component, or a combination thereof. The processor 120 is coupled to the memory 110 and may load and execute the wake-up detection module 112, the battery data collection and analysis module 114, and the power saving system module 116 stored in the memory 110, thereby performing power saving functions. With reference to FIG. 1, FIG. 2, and FIG. 4, a power saving method provided in this embodiment is applicable to the electronic device 100 depicted in FIG. 1. Each step of the power saving method provided in one or more embodiments of the disclosure is explained with reference to various components in the electronic device 100.

Firstly, in step S400, in the low power consumption mode, the wake-up detection module 112 receives the wake-up event Wsys.

Next, in step S420, the wake-up detection module 112 determines whether the currently received wake-up event Wsys is the unexpected wake-up event. When the wake-up event Wsys is not the unexpected wake-up event, it indicates that the currently received wake-up event Wsys is the expected wake-up event initiated by the background applications operating in the background. At this time, please return to step S400 and wait until the next wake-up event Wsys is received.

When the wake-up event Wsys is the unexpected wake-up event, it indicates that the currently received wake-up event Wsys is not the expected wake-up event initiated by the background applications operating in the background. In step S440, the battery data collection and analysis module 114 receives an analysis instruction Ad sent by the wake-up detection module 112 and analyzes the collected battery statistic data Dbs to generate an analysis result Ar. Specifically, at a timing of receiving the unexpected wake-up event, the battery data collection and analysis module 114 may, based on the battery statistic data Dbs, identify a plurality of target applications that have been running and have woken up the system in the past from the background applications running in the background and record the identified target applications in the analysis result Ar. In an embodiment, the battery data collection and analysis module 114 may also limit the search scope to the target applications that have woken up the system within a period (e.g., several hours) in the past, which should however not be construed as a limitation in the disclosure.

Finally, in step S460, the power saving system module 116 adjusts the status of the background applications operating in the background based on the analysis result Ar. In detail, as shown in FIG. 4, the step S460 includes steps S462, S464, and S466. In step S462, the power saving system module 116 checks the status of the target applications (i.e., the background applications that have been running and have woken up the system in the past) recorded in the analysis result Ar, and in step S464, the power saving system module 116 determines whether each target application is in an app standby mode. In the present embodiment, if a background application has been idle for a period and has transitioned to the app standby mode, it indicates that the background application has completed its predetermined activity. The background applications in the app standby mode, for instance, may delay or prohibit activities, such as jobs, syncs, standard alarms, and so on, so as to reduce the activities.

In step S466, the power saving system module 116 removes the target applications in the app standby mode from the background, thereby forcibly shutting down the target applications in the app standby mode to release system resources and prevent the target applications from waking up the system because the target applications still have unexpected network activities, which may lead to unnecessary power consumption.

Besides, in the step S466, the power saving system module 116 further enables the target applications that are not in the app standby mode to enter the app standby mode, thereby reducing the activities of the operating target applications and further avoiding excessive use of the system resources and excessive power consumption during standby.

To sum up, the electronic device and the power saving method thereof, as described in one or more embodiments of the disclosure, may be applied to detect the unexpected wake-up events and in response dynamically adjust the status of the background applications operating in the background, so as to sequentially discontinue the unnecessary background applications and reduce the activities of the background applications that are still running. As such, the system resources may be appropriately released, resulting in the optimal power saving outcomes and the enhanced user experiences.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A power saving method, adapted to an electronic device and comprising:
receiving a wake-up event in a low power consumption mode;
determining whether the wake-up event is an unexpected wake-up event;
when the wake-up event is the unexpected wake-up event, analyzing battery statistic data to generate an analysis result; and
adjusting a status of a plurality of background applications operating in a background according to the analysis result.

2. The power saving method as claimed in claim 1, wherein the unexpected wake-up event is not the wake-up event initiated by the background applications.

3. The power saving method as claimed in claim 1, wherein the battery statistic data comprise daily log data recording an activity history of each of the background applications.

4. The power saving method as claimed in claim 1, wherein the step of analyzing the battery statistic data to generate the analysis result comprises:
at a timing of receiving the unexpected wake-up event, according to the battery statistic data, identifying a plurality of target applications that have woken up a system from the background applications and recording the target applications in the analysis result.

5. The power saving method as claimed in claim 4, wherein the step of adjusting the status of the background applications operating in the background according to the analysis result comprises:
checking a status of the target applications;
determining whether each of the target applications is in an app standby mode; and
removing the target applications that are in the app standby mode from the background and enabling the target applications that are not in the app standby mode to enter the app standby mode.

6. An electronic device, comprising:
a memory, storing a plurality of modules; and
a processor, coupled to the memory and loading and executing the modules stored in the memory, the modules comprising:
a wake-up detection module, receiving a wake-up event in a low power consumption mode and determining whether the wake-up event is an unexpected wake-up event;
a battery data collection and analysis module, analyzing battery statistic data when the wake-up event is the unexpected wake-up event to generate an analysis result; and
a power saving system module, adjusting a status of a plurality of background applications operating in a background according to the analysis result.

7. The electronic device as claimed in claim 6, wherein the unexpected wake-up event is not the wake-up event initiated by the background applications.

8. The electronic device as claimed in claim 6, wherein the battery statistic data comprise a daily log data recording an activity history of each of the background applications.

9. The electronic device as claimed in claim 6, wherein at a timing of receiving the unexpected wake-up event, according to the battery statistic data, the battery data collection and analysis module identifies a plurality of target applications that have woken up a system from the background applications and records the target applications in the analysis result.

10. The electronic device as claimed in claim 9, wherein the power saving system module determines whether each of the target applications is in an app standby mode, removes the target applications that are in the app standby mode from the background, and enables the target applications that are not in the app standby mode to enter the app standby mode.
